(19) United States
(12) Patent Application Publication
(10) Pub. No.: US 2022/0250953 A1
(43) Pub. Date: Aug. 11, 2022

(54) EFFICIENT ELECTROCHEMICAL PRE-SCALING WATER TREATMENT DEVICE

(71) Applicants: CHINA NATIONAL CHEMICAL ENGINEERING NO.14 CONSTRUCTION CO., LTD., Nanjing City, Jiangsu (CN); JIANGSU RUNJU ENVIRONMENTAL TECHNOLOGY CO., LTD., Nanjing City, Jiangsu (CN)

(72) Inventors: Dong Gao, Nanjing City (CN); Mengxiao Niu, Nanjing City (CN); Junfeng Zhu, Nanjing City (CN); Pingli Bao, Nanjing City (CN); Wei Wang, Nanjing City (CN); Wei Zhou, Nanjing City (CN)

(73) Assignees: CHINA NATIONAL CHEMICAL ENGINEERING NO.14 CONSTRUCTION CO., LTD., Nanjing City, Jiangsu (CN); JIANGSU RUNJU ENVIRONMENTAL TECHNOLOGY CO., LTD., Nanjing City, Jiangsu (CN)

(21) Appl. No.: 17/600,429

(22) PCT Filed: Aug. 21, 2020
(86) PCT No.: PCT/CN2020/110498

§ 371 Date: Apr. 8, 2022

(30) Foreign Application Priority Data
Jan. 16, 2020 (CN) 202010048668.9
Jan. 16, 2020 (CN) 202020095461.2

(51) Int. Cl. C02F 1/46; C02F 1/461

(52) U.S. Cl. CPC C02F 1/4602; C02F 1/46109; C02F 2001/46119; C02F 2103/023; C02F 2001/46133; C02F 2201/46105; C02F 2001/46157

(57) ABSTRACT

An efficient electrochemical pre-scaling water treatment device is disclosed. The device comprises an enclosed box, wherein anode positioning connecting shafts, anode plates, cathode plates and scrapers are distributed in a length direction of the closed box, the scrapers are fixed to a scraper holder, the anode plates are fixed to the anode positioning connecting shafts, and the cathode plates are fixed to a central shaft; the anode positioning connecting shafts, the scraper holder and the central shaft are fixed on the enclosed box; in the width direction of the enclosed box, a water inlet is provided at a first side of the enclosed box, a water outlet and a sewage outlet are provided at a second side of the enclosed box, and exhaust holes are provided at a top of the enclosed box.

### TECHNICAL FIELD

The present disclosure belongs to the technical field of environmental protection equipment, and in particular to an efficient electrochemical pre-scaling water treatment device that removes scale-forming ions in water in advance with high efficiency, and is particularly suitable for the conditions with relatively high content of calcium ions and magnesium ions.

### BACKGROUND ART

Circulating water is essential for many fields in the industry, and tends to form scale which is a substance with extremely poor thermal conductivity during heat exchange. The existence of scale will greatly reduce the heat transfer efficiency of heat exchange equipment, resulting in increased fuel consumption, high energy consumption and pollution to the environment. Meanwhile, scaling is always accompanied by corrosion, which shortens the service life of the equipment, and may even cause explosion, causing safety accidents. The existence of scale causes great distress to enterprises, since scale clearing is complicated and tedious, which requires not only disassembly of equipment and pipelines, but also stop of work and production, and consumes a lot of labor costs.

At present, the existing descaling methods mainly include a water pretreatment method, a physical method, a chemical method, and the like. The water pretreatment method adopts ions exchange equipment to replace the scale-forming ions in water in advance. However, an exchange medium in the equipment needs to be replaced regularly, and the equipment is unstable in work efficiency. The physical method generally adopts electromagnetic or strong magnetic treatment methods to prevent the scale-forming ions in the water from combining into scale. However, the scale inhibition and descaling effect of this method has poor reception in the market. In the chemical method, chemicals are added to the circulating water to prevent scale from forming. This method is costly and easy to cause secondary pollution.

As large-scale application of an electrochemical treatment technology in various fields, an electrochemical pre-scaling treatment technology has progressively developed, and various types of electrochemical pre-scaling equipment has emerged, which have obvious descaling effects. However, the effect cannot reach expectation. The reason is that the existing electrochemical pre-scaling equipment is too small in the operational capacity, has large fluctuation when used in combination, occupies a large area, and is low in universality. In view of this, it is desirable to develop and manufacture an efficient electrochemical pre-scaling water treatment device.

### SUMMARY

In order to solve the above problems, the present discourse discloses an efficient electrochemical pre-scaling water treatment device. In order to achieve the above objective, the present disclosure provides the following technical solution:

An efficient electrochemical pre-scaling water treatment device includes an enclosed box, anode positioning connecting shafts, anode plates, cathode plates and scrapers which are distributed in a length direction of the enclosed box, where, the scrapers are fixed to a scraper holder, the anode plates are fixed to the anode positioning connecting shafts, and the cathode plates are fixed to a central shaft; the anode positioning connecting shafts, the scraper holder, and the central shaft are fixed to the enclosed box; in a width direction of the enclosed box, a water inlet is provided at a first side of the enclosed box, and a water outlet and a sewage outlet are provided at a second side of the enclosed box; exhaust holes are provided at a top of the enclosed box.

Further, the anode plates each include a left half anode plate and a right half anode plate, the left half anode plate and the right half anode plate have same structure and are arranged symmetrically, and the anode plates each are in a shape of a semicircle or a rectangle; a semicircular groove is provided at a center of a first side of the left half anode plate which is adjacent to the right half anode plate and a side of the right half anode plate which is opposite to the first side is provided with a semicircular groove; the semicircular groove is configured to allow the central shaft to pass through, and a position of the semicircular groove corresponds to a position of the central shaft; two perforations are provided symmetrically at an upper portion and an lower portion of each of the anode plates; the perforations are configured to allow the anode positioning connecting shafts to pass through, and a position of each of the perforations corresponds to a position of a corresponding one of the anode positioning connecting shafts; and a number of the anode positioning connecting shafts are four. Four perforations are configured to allow the anode positioning connecting shafts to pass through, facilitating accurate positioning of the anode plates and realizing the supporting of the anode plates. The two grooves that are symmetrical are configured to allow the central shaft to pass through.

In one embodiment, one central shaft is provided, a through hole is provided at a center of each of the cathode plates, the through hole is configured to allow the central shaft to pass through, and a position of the through hole corresponds to a position of the central shaft.

In one embodiment, the anode positioning connecting shaft, the scraper holder, and the central shaft are fixed to the enclosed box via external bolts.

In one embodiment, a basic material of the anode plates is titanium, and the semicircular grooves of the anode plates are plated with ruthenium iridium, iridium tantalum or platinum precious metal on both sides.

In one embodiment, the cathode plates and the anode plates are arranged and mounted alternately in sequence inside the enclosed box. A number of cathode plates and anode plates and a size of the device can be adjusted accordingly in accordance with treatment requirements of different fields and different water quality conditions.

In one embodiment, the water outlet is located above the water inlet, and the sewage outlet is located below the water inlet.

In one embodiment, inner and outer sides of each of the cathode plates each are matched with corresponding one of the scrapers, and for two outermost cathode plates, only inner side of each of the outermost cathode plates is matched with corresponding one of the scrapers.

In one embodiment, the scrapers each are a V-shaped scraper, the scrapers are mounted to the scraper holder in a hook and groove connection manner, a first end of each of the scrapers is provided with a clamping part, the scraper holder is provided with clamping grooves and the clamping part is engaged with corresponding one of the clamping grooves. The scale attached to an inner wall of the pre-scaling water treatment device can be effectively cleared. This V-shaped scraper is simple to use and automatically collects the scale during scale scraping.

The present embodiment has the following working principle and beneficial effects: the anode plates and the cathode plates are the main body for achieving the effect of the device. The anode plates each are of a centrosymmetric or square structure connected by the anode positioning connecting shafts which also act to conduct electricity, such that the anode plates are convenient to disassemble and assemble, easy to operate, and equipment weight and consumables are reduced. The scrapers are configured to mechanically remove scale layers generated on the cathode plates, and the scraper holder is configured to accurately fix the scrapers. The central shaft is configured to fix all the cathode plates and acts to conduct electricity, and the rotation of the central shaft drives the cathode plates to rotate. The water inlet, the water outlet, and the sewage outlet are configured for water flowing into, water flowing out and sewage discharging during the operation of the device.

The enclosed box is used as a reaction chamber. Water to be treated enters the device through the water inlet, and enters a next system through the water outlet after treatment. The sewage outlet is configured to discharge sewage generated by the device.

The efficient electrochemical pre-scaling water treatment device will be mounted as a whole after assembly without special requirements. When the device is in operation, the water to be treated enters the device through the water inlet, and the water to be treated flows out through the water outlet after being treated by the device. Direct current is applied during the operation, the anode plates conduct electricity through the anode positioning connecting shafts, and the cathode plates conduct electricity through the central shaft. The cathode plates rotate under the drive of the central shaft. During the operation, scale layers will be continuously generated on the cathode plates, and the scrapers can scrape the generated scale layers off by coming into close contact with the cathode plates. Some hydrogen and chlorine will be generated during an electrolysis process, which will be discharged through the exhaust hole at the top of the enclosed box.

After the water normally flows into and out of the device is normal, a direct current is supplied, and meanwhile, an external motor drives the central shaft to continuously rotate slowly at 4-15 r/h, preferably 8 r/h, for a period of time. The sewage outlet is opened to discharge the sewage. A sewage discharge cycle varies from one water quality to another, and is generally controlled at 1 to 2 times/day. When the sewage is discharged, the water inlet and the water outlet are not closed, and the sewage outlet is closed after the sewage is discharged for 120 s. An electric ball valve is connected to the sewage outlet, and is controlled by an equipment control program.

### BRIEF DESCRIPTION OF THE DRAWINGS

FIG. 1 is a schematic diagram of an inner structure of an efficient electrochemical pre-scaling water treatment device according to the present disclosure.

FIG. 2 is a schematic diagram of a structure of an anode plate of the present disclosure.

FIG. 3 is a schematic diagram of a structure of a cathode plate of the present disclosure.

FIG. 4 is a schematic diagram of water inlet and water outlet of the water treatment device.

FIG. 5 is a top view of the water treatment device.

FIG. 6 is a top view of a scraper.

FIG. 7 is a front view of the scraper.

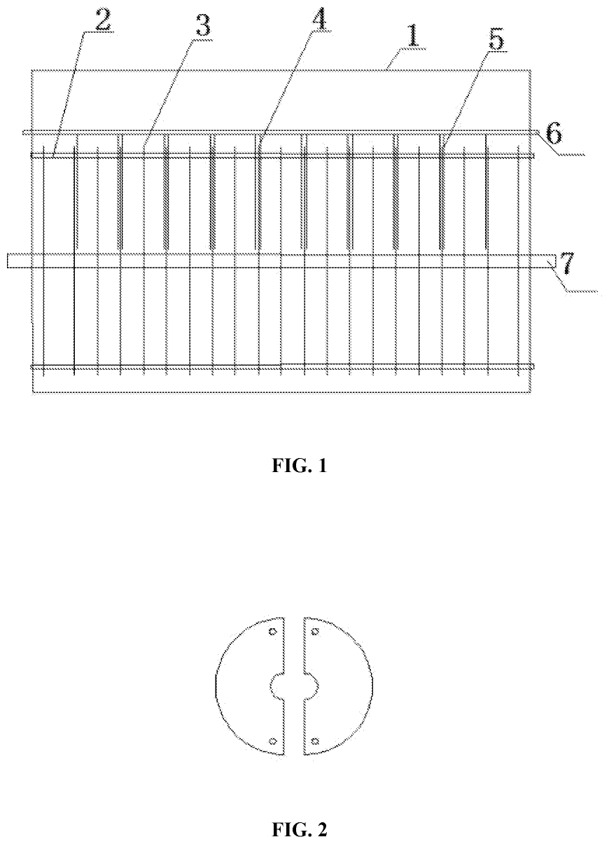

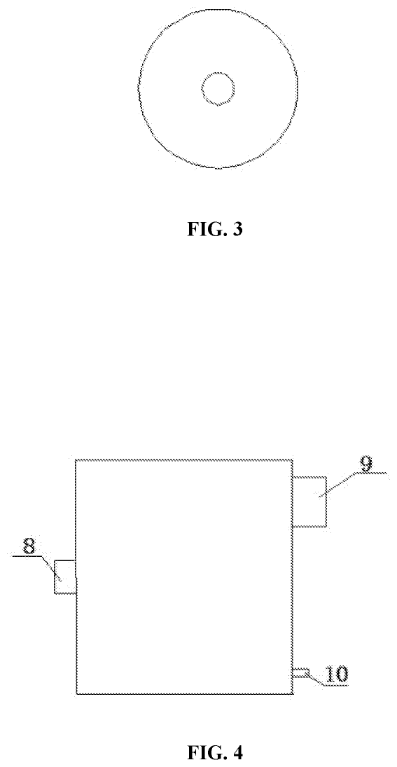

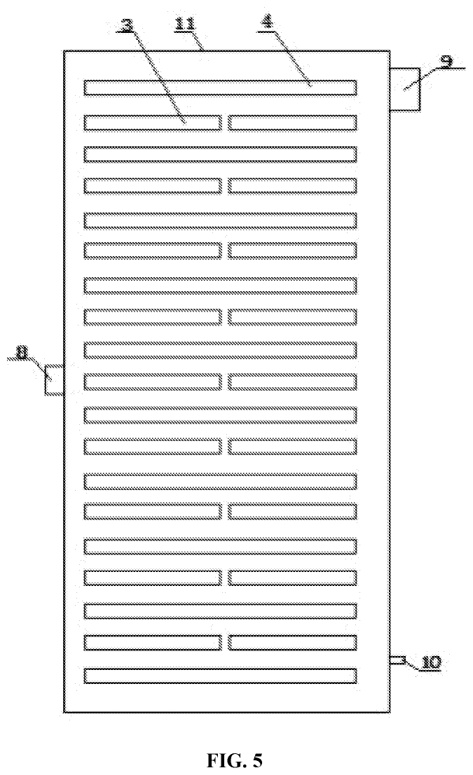

Reference numerals: 1, box; 2, anode positioning connecting shaft; 3, anode plate; 4, cathode plate; 5, scraper; 6, scraper holder; 7, central shaft; 8, water inlet; 9, water outlet; 10, sewage outlet; 11, exhaust hole; 12, clamping part; and 13, clamping groove.

### DETAILED DESCRIPTION OF THE EMBODIMENTS

The present disclosure will be further described below in conjunction with the drawings and specific implementations. It should be understood that the following specific implementations are merely used to illustrate the present disclosure and not to limit the scope of the present disclosure.

The present disclosure provides an efficient electrochemical pre-scaling water treatment device, which can efficiently remove calcium ions and magnesium ions present in water. The device has high treatment efficiency and is applicable to various fields that need to remove calcium ions and magnesium ions. Cathodes and anodes are arranged and mounted alternately in sequence inside the device. The overlap area between any two adjacent cathode and anode is large and the space required for the cathodes and the anodes is small. The numbers of the cathodes and anodes and a size of the device can be adjusted accordingly in accordance with treatment requirements of different fields and different water quality conditions. The maximum number of the anodes may be 20. To ensure the effect, the efficient pre-scaling device may also be used in combination with other devices. The numbers of cathode plates and anode plates can be selected as required. Here, an efficient electrochemical pre-scaling water treatment device including 10 cathode plates and 9 anode plates will be illustrated as an example.

As shown in the figures, the efficient electrochemical pre-scaling water treatment device includes an enclosed box 1 as the main body. Anode positioning connecting shafts 2, anode plates 3, cathode plates 4 and scrapers 5 are distributed in a length direction of the enclosed box. The scrapers 5 are fixed to a scraper holder 6, the anode plates 3 are fixed to the anode positioning connecting shafts 2, and the cathode plates 4 are fixed to a central shaft 7. The cathode plates 4 and the anode plates 3 are arranged and mounted alternately in sequence inside the enclosed box 1.

The numbers of the cathode plates and anode plates and a size of the device can be adjusted accordingly in accordance with treatment requirements of different fields and different water quality conditions. In a width direction of the enclosed box 1, a water inlet 8 is provided at a first side of enclosed box 1, a water outlet 9 and a sewage outlet 10 are provided at a second side enclosed box 1, and exhaust holes 11 are provided at a top of the enclosed box 1.

Each of inner and outer sides of each cathode plate 4 corresponds to and in close contact with one scraper 5, and for two outermost cathodes, only inner side of each outermost cathode corresponds to one scraper 5. Each anode plate 3 includes a left half anode plate and a right half anode plate, the left half anode plate and the right half anode plate have the same structure and are arranged symmetrically, and the shape of each half anode plate includes but is not limited to a semicircle or a rectangle.

A center of one side of the left half anode near the right half anode and a center of one side of the right half anode near the left half anode are provided with semicircular grooves respectively. The semicircular grooves are configured to allow the central shaft 7 to pass through, and the positions of the semicircular grooves correspond to the position of the central shaft 7. Each half anode plate is provided with two perforations which are arranged symmetrically at upper portion and lower portion of the half anode plate. The perforations are configured to allow the anode positioning connecting shafts to pass through, and a position of each perforation corresponds to a position of a respective one of the anode positioning connecting shafts 2. Four anode connecting shafts are provided.

Four perforations are configured for each anode plate to allow the anode connecting shafts to pass through, facilitating accurate positioning of the anode plate and realizing the supporting of the anode plate. The two semicircular grooves that are symmetrical are configured to allow the central shaft 7 to pass through. One central shaft 7 is provided, a through hole is provided at a center of each cathode plate 4, the through hole is configured to allow the central shaft 7 to pass through, and a position of the through hole corresponds to a position of the central shaft 7.

The enclosed box is used as a reaction chamber. Water to be treated enters the device through the water inlet, and enters a next system through the water outlet after treatment. The sewage outlet is configured to discharge sewage generated by the device.

Four perforations in the anode plate are configured to allow the anode positioning connecting shafts to pass through respectively, facilitating the accurate positioning of the anode and realizing the supporting of the anode. The anode plates and the cathode plates are the main body for achieving the effect of the device. The anode plates each are of a centrosymmetric circular or square structure, which is connected by the anode positioning connecting shafts that also function to conduct electricity, such that the anode plates are convenient to disassemble and assemble, easy to operate, and equipment weight and consumables are reduced. The scrapers are configured to mechanically remove scale layers generated on the cathode plates, and the scraper holder is configured to accurately fix the scrapers. The central shaft is configured to fix all the cathode plates and acts to conduct electricity, and the rotation of the central shaft 7 drives the cathode plates to rotate.

The water inlet, the water outlet, and the sewage outlet are configured for water flowing out, water flowing into and sewage discharging processes during the operation of the device.

The efficient electrochemical pre-scaling water treatment device will be mounted as a whole after assembly without special requirements. When the device is in operation, the water to be treated enters the device through the water inlet, and the water to be treated flows out through the water outlet after being treated by the device. Direct current is applied during the operation, the anode plates conduct electricity through the anode positioning connecting shafts, and the cathode plates conduct electricity through the central shaft. The cathode plates rotate under the drive of the central shaft. During the operation, scale layers will be continuously generated on the cathode plates, and the scrapers can scrape the generated scale layers off by coming into close contact with the cathode plate. Some hydrogen and chlorine are generated during an electrolysis process, which will be discharged through the exhaust holes at the top of the enclosed box. The anode positioning connecting shafts, the scraper holder, and the central shaft are fixed to the enclosed box by external bolts.

After the water normally flows into and out of the device, a direct current is supplied, and meanwhile, an external motor drives the central shaft to continuously rotate slowly at 4-15 r/h, preferably 8 r/h, for a period of time. Then, the sewage outlet is opened to discharge the sewage. The sewage discharge cycle varies from one water quality to another, and is generally controlled at 1 to 2 times/day. When the sewage is discharged, the water inlet and the water outlet are not closed, and the sewage outlet is closed after the sewage is discharged for 120 s. An electric ball valve is connected to the sewage outlet, and is controlled by an equipment control program.

The anode plates and the cathode plates are of a centrosymmetric structure, may also be hollowed out, and are not limited to the structure described above.

Embodiment I: As shown in the figures, the iron enclosed box 1 has a size of L*W*H=1200 mm*1000 mm*1100 mm, and includes six boards respectively in front, back, left, right, top and bottom. The material of the body is Q235B carbon steel. A thickness of the carbon steel plate is 6.5 mm. An exterior of the enclosed box is subjected to anti-corrosion treatment, which is completed by polishing, sandblasting, primer coating and top paint coating. An interior of the enclosed box is subjected to insulating treatment, i.e., PE boards with a thickness of 3 mm is tightly fixed to inner side walls of the enclosed box to isolate water from the steel. There are four anode positioning connecting shafts 2 distributed up and down in total, which have an overall length of 1400 mm, a solid round shaft shape, and an outer diameter of 15 mm, and are made of 316 stainless steel. Both ends of each shaft are tapped with external threads. The threaded parts both have a length of 100 mm, are configured to fix the shaft to the enclosed box 1, and also facilitate electricity accessing.

Taking circular anode plates 3 as an example, the anode plates are of centrosymmetric structure, each anode plate includes two semicircular plate structures each with a semicircular hole with a radius of 50 mm opened in the center. A radius of a circular coating is 250 mm. The two semicircular holes are concentric. Two perforations are provided in each semicircle plate, and tapped with internal threads. A radius of each perforation is 7.5 mm, and the shortest distance between the center of the perforation and an arc edge of the semicircular plate is 37.5 mm. A distance between each of the centers of the two perforations and a diameter parallel to a connection line for the two centers of the two perforations is 37.5 mm. The anode plates 3 are mainly made of titanium plates with a thickness of 3 mm, and central circle ring portions thereof are plated with ruthenium iridium, iridium tantalum or platinum precious metal on both sides with a coating thickness of 0.2-5 μm.

The cathode plates 4 are circular plates each with a circular hole having a radius of 45 mm in the center. A radius of each circular plate is 250 mm. The circular plate and circular hole are concentric. The cathode plates are mainly made of 316 stainless steel or high manganese steel, with surfaces polished, and each have a thickness of 3 mm.

The scrapers 5 are fixed to the scraper holder 6, each are in a sheet shape, each have the thickness of 1 mm, the width of 10 mm, and the length of 290 mm, and are made of 316 stainless steel or high manganese steel. Each of inner and outer sides of each cathode plate 4 corresponds to one scraper 5. The scraper is closely attached to the adjacent electrode plate, which is beneficial to the removal of scale. For two outermost cathodes, only inner side of each outermost cathode plate corresponds to one scraper.

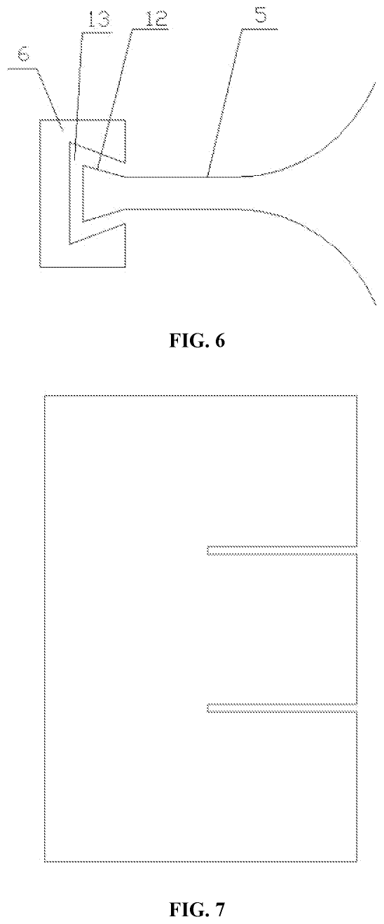

For a scraper structure shown in FIGS. 6-7, the scraper is a V-shaped scraper, and a bottom end of the scraper is mounted to the scraper holder in a hook and groove connection manner. A first end of the scraper is provided with a clamping part 12, the scraper holder is provided with clamping grooves 13, and the clamping part is engaged with a corresponding clamping groove. The scale attached to an inner wall of the pre-scaling water treatment device can be effectively cleared, by this V-shaped scraper which is simple to use and automatically collects the scale during scale scraping. The scrapers are provided in pairs and arranged in rows. Multiple pairs are provided in one row, so that it is convenient to disassemble and replace, and the scraper is not easy to deform.

The center of the scraper holder 6 is 685 mm away from a bottom plate of the device, and the scraper holder has an overall length of 1350 mm. The scraper holder is in a shape of a circular shaft which is solid and has an outer diameter of 30 mm, and is made of 316 stainless steel. Both ends of the shaft are tapped with external threads. The threaded parts both have a length of 75 mm, and are configured to fix the circular shaft to the enclosed box 1. The enclosed box 1 is provided with two holes having a radius of 15 mm at positions 685 mm away from the bottom plate in the center line along the width direction, and the two holes are respectively located at two ends of the enclosed box 1.

The center of the central shaft 7 is 350 mm away from the bottom plate, and the central shaft has an overall length of 1600 mm. It is a solid circular shaft with an outer diameter of 90 mm, and is made of 316 stainless steel. The central shaft needs to be polished. Both ends of the central shaft are tapped with external threads. The threaded parts both have a length of 200 mm, and are configured to fix the central shaft to the enclosed box 1. The enclosed box 1 is provided with two holes having a radius of 45 mm at positions 350 mm away from the bottom plate in the center line along the width direction, and the two holes are respectively located at the two end of the enclosed box 1.

The water inlet 8 has a size of DN150, with a center 550 mm away from the bottom plate in the center line along the length direction, and is connected to a 316 stainless steel pipe with the length of 750 mm. An inner diameter of the steel pipe is 150 mm. A DN150 flange is soldered to an outer end of the steel pipe.

The water inlet 9 has a size of DN300, with a center 750 mm away from the bottom plate in the center line along the length direction, and is connected to a 316 stainless steel pipe with the length of 100 mm. An inner diameter of the steel pipe is 300 mm. A DN300 flange is soldered to an outer end of the steel pipe.

The sewage outlet 10 has a size of DN100, with a center 6mm away from the bottom plate in the center line along the length direction, and is connected to a 316 stainless steel pipe with the length of 50 mm. An inner diameter of the steel pipe is 100 mm. A DN100 flange is soldered to an outer end of the steel pipe.

There are 5 exhaust holes 11 in total. Each exhaust hole is rectangular, with a size of 900 mm*50 mm. The center of one exhaust hole is exactly at the center of the top. The other four exhaust holes are arranged in sequence with the one exhaust hole as a reference, and a distance between each two adjacent exhaust holes is 100 mm.

A distance between the anode plate 3 and the adjacent cathode plate 4 is 50 mm. The device is operated under normal pressure, the exhaust holes are provided at the top, the lowest point of the water outlet 9 is the highest point of the electrode, thus ensuring the work stability of the electrodes.

The center holes of the cathode plates 4 are matched with the central shaft 7 in size, and can realize a tight connection with the central shaft 7 via a key and groove connection manner. The two are both made of 316 stainless steel. It is only needed to connect the cathode plates to the central shaft 7 when powering on. In order to avoid winding, a sleeve is used to conduct electricity, so that the central shaft 7 rotates while the sleeve does not rotate, so as to conduct electricity. The anode plates 5 are connected by the anode positioning connection shafts 8, specifically, in a parallel connection manner.

The cathode plates and the anode plates of the efficient electrochemical pre-scaling water treatment device are closely arranged and directly face to each other, so as to reduce a resistance, and ensure the current distribution stability, thereby finally maximizing the treatment efficiency. In operation, a control voltage is 12-24 V, a design current is 600-800 A, and an actual current varies according to a water flow speed, water conductivity, and a temperature. When the device is applied in an industrial circulating cooling water system, a high current can not only efficiently remove the calcium ions and magnesium ions, but also can realize concentrate production of a large number of strong oxides, such as ozone, oxygen free radical, hydroxyl free radical and hydrogen peroxide, which can achieve the functions of disinfection, algae removal, and corrosion inhibition.

Compared with the same type of electrochemical pre-scaling device, the device of the present embodiment improves the work efficiency, while reducing the relative volume of the device and reducing the amount of sewage discharged. To ensure the treatment effect of the water entering the device through the water inlet 8, the enclosed box is designed to be relatively large, with 243.5 mm space reserved at both ends in the width direction, to achieve the purpose of water flow speed reduction, thereby ensuring the processing effect of the equipment.

The working principle of the efficient electrochemical pre-scaling water treatment device includes the following.

1) After the water to be treated enters the enclosed box, an electrochemical reaction occurs, and a large amount of hydroxide ions are generated near the cathode plates, so that a strong alkali environment (pH is about 10) is formed in this area to allow ions that are prone to scaling to be pre-scaled and attached to the cathode plates. The main chemical reaction equations are as follows:

2H₂O+2e⁻→H₂+2OH⁻CO₂+OH⁻→HCO₃⁻²H₂O+2e⁻→H₂+2OH⁻

HCO₃⁻+OH⁻→CO₃²⁻+H₂O CO₃²⁻+Ca²⁺→CaCO₃↓(scale)

2) Near the anode plates, chlorine ions are converted into free chlorine by electrochemical reaction, and a trace amount of ozone, oxygen free radicals, hydroxyl free radicals and hydrogen peroxide are generated at the same time. These products all have strong oxidizing property, and thus have the effect of disinfection and algae removing in combination with current and local high and low (anode) pH values. The main chemical reaction equations are as follows:

O₂+2OH⁻→O₃+H₂O+2e⁻²Cl⁻→Cl₂+2e⁻

Cl⁻→Cl⁰+e⁻²H₂O→H₂O₂+2H⁺+2e⁻

Specific implementations and implementation results are described as follows.

When the efficient electrochemical pre-scaling water treatment device is used in the circulating water system, the treatment effect is mainly reflected by the change trend of the calcium ions and chloride ions in the circulating water within a certain period.

When the device is applied to concentrate treatment in water desalination station, reclaimed water treatment, sewage treatment, oilfield reinjection water treatment, the treatment effect is mainly reflected by the change trend of the calcium ions and magnesium ions during one-time treatment. In order to better reflect the long-term operation effect of the device, here, described is the situation of the device applied to the circulating water system. In an existing industrial circulating cooling water system, a water holding volume is 3000 m³, a water circulation rate is 10000 m³/h, and an concentration times during operation is 3. With a electrochemical pre-scaling water treatment device (including 9 anode pairs which are ruthenium iridium anodes, high manganese steel cathodes, a current of 600 A, a voltage of 12 V, a rotational speed of 8 r/h), after operation for three months, the concentration times of the circulating water system is stably controlled to 6, and the calcium concentration and the concentration of chloride ions in the circulating water system are both effectively controlled.

TABLE 1
The change trend of key ion concentrations

| | Original | One | Two | One | Three months |
|---|---|---|---|---|---|
| Item | system | week | weeks | month | and later |
| Calcium hardness | 520 | 420 | 370 | 330 | ≤300 |
| (mg/L) | | | | | |
| Chloride ion | 400 | 350 | 320 | 300 | ≤290 |
| (mg/L) | | | | | |

Effective control on the calcium hardness can reduce the scaling tendency of the system, improve the heat exchange efficiency, and ensure the operation stability of the system. The reduction of chloride ion content will greatly reduce the corrosion of pipelines and the heat exchanger and extend the operation time of the system.

Beneficial Effects:

The efficient electrochemical pre-scaling water treatment device is mainly configured to remove the calcium ions and magnesium ions, especially suitable for the removal of the calcium ions and magnesium ions in the processes including chemical circulating water treatment, circulating water treatment of power plant, concentrate treatment in water desalination station, reclaimed water reuse treatment, sewage treatment, and oilfield reinjection water.

When applied to the industrial circulating water treatment, the device can not only realize the removal of the calcium ions and magnesium ions, but also realize the functions of disinfection, algae removing and corrosion inhibition, thus completely replacing the existing mode of adding chemical agents to control circulating water operation. Meanwhile, the device can also increase the concentration times of the circulating water system during operation. The increase of the concentration times will greatly reduce the amount of supplement water and discharged sewage, thereby reducing the treatment cost of supplement water and discharged sewage. The emergence of the device will gradually change the operation mode of the existing circulating water system, i.e., adding chemical agents, and promote the development of the treatment mode of the circulating water system toward the direction of clean, environmental-friendly and energy-saving.

The technical means disclosed in the solutions of the present disclosure are not limited to the technical means disclosed in the above-mentioned implementations, but also include the technical solutions consisting of any combination of the above technical features. It should be pointed out that for a person of ordinary skill in the art, without departing from the principle of the present disclosure, several improvements and modifications can be made, and these improvements and modifications are also fall within the protection scope of the present disclosure.

What is claimed is:

1. An efficient electrochemical pre-scaling water treatment device, comprising an enclosed box, anode positioning connecting shafts, anode plates, cathode plates and scrapers which are distributed in a length direction of the enclosed box, wherein, the scrapers are fixed to a scraper holder, the anode plates are fixed to the anode positioning connecting shafts, and the cathode plates are fixed to a central shaft; the anode positioning connecting shafts, the scraper holder, and the central shaft are fixed to the enclosed box; in a width direction of the enclosed box, a water inlet is provided at a first side of the enclosed box, and a water outlet and a sewage outlet are provided at a second side of the enclosed box; exhaust holes are provided at a top of the enclosed box; the anode plates each comprise a left half anode plate and a right half anode plate, the left half anode plate and the right half anode plate have same structure and are arranged symmetrically, and the anode plates each are in a shape of a semicircle or a rectangle; a semicircular groove is provided at a center of a first side of the left half anode which is near the right half anode; the semicircular groove is configured to allow the central shaft to pass through, and a position of the semicircular groove corresponds to a position of the central shaft; two perforations are provided symmetrically at an upper portion and an lower portion of each of the anode plates; the perforations are configured to allow the anode positioning connecting shafts to pass through, and a position of each of the perforations corresponds to a position of a corresponding one of the anode positioning connecting shafts; and a number of the anode positioning connecting shafts are four.

2. The efficient electrochemical pre-scaling water treatment device according to claim 1, wherein a number of the central shaft is one, a through hole is provided at a center of each of the cathode plates, the through hole is configured to allow the central shaft to pass through, and a position of the through hole corresponds to a position of the central shaft.

3. The efficient electrochemical pre-scaling water treatment device according to claim 1, wherein the anode positioning connecting shafts, the scraper holder, and the central shaft are fixed to the enclosed box via external bolts.

4. The efficient electrochemical pre-scaling water treatment device according to claim 1, wherein the water outlet is located above the water inlet, and the sewage outlet is located below the water inlet.

5. The efficient electrochemical pre-scaling water treatment device according to claim 1, wherein a basic material of the anode plates is titanium, and central semicircular ring portions of the anode plates are plated with ruthenium iridium, iridium tantalum or platinum precious metal on both sides.

6. The efficient electrochemical pre-scaling water treatment device according to claim 1, wherein the cathode plates and the anode plates are arranged and mounted alternately in sequence inside the enclosed box.

7. The efficient electrochemical pre-scaling water treatment device according to claim 1, wherein inner and outer sides of each of the cathode plates each are matched with corresponding one of the scrapers, and for two outermost cathode plates, only inner side of each of the outermost cathode plates is matched with corresponding one of the scrapers.

8. The efficient electrochemical pre-scaling water treatment device according to claim 7, wherein the scrapers each are a V-shaped scraper, the scrapers are mounted to the scraper holder in a hook and groove connection manner, a first end of each of the scrapers is provided with a clamping part, the scraper holder is provided with clamping grooves, and the clamping part is engaged with corresponding one of the clamping grooves.
